(19) United States
(12) Patent Application Publication
(10) Pub. No.: US 2006/0023455 A1
(43) Pub. Date: Feb. 2, 2006

(54) Remote-controlled locator light apparatus

(76) Inventor: Michael E. Hardin, Utica, MI (US)

Correspondence Address: S. Michael Bender, P.O. Box 530-399, St. Petersburg, FL, 33747, US

(21) Appl. No.: 11/194,725

(22) Filed: Aug. 1, 2005

Related U.S. Application Data
(60) Provisional application No. 60/592,641, filed on Aug. 2, 2004.

(51) Int. Cl. F21V 33/00

(52) U.S. Cl. 362/253

(57) ABSTRACT

A remote-controlled locator light apparatus includes a battery—powered portable transmitter unit for transmitting an activation signal. A battery—powered portable remote-controlled locator light unit receives the activation signal and is activated by the activation signal to emit a visible light signal. A strap assembly is provided for suspending the portable remote-controlled locator light unit from an object, such as a branch of a tree on which a tree stand is installed. The transmitter unit transmits an electromagnetic activation signal, and the remote-controlled locator light unit receives the electromagnetic activation signal and is activated thereby. In the portable remote-controlled locator light unit, a receiver assembly causes a signal driver assembly to drive or illuminate a light source. A housing includes transparent light source covers adjacent to the light source and substantially surrounding the light source for allowing light rays emitted from the light source to pass therethrough.

### CROSS-REFERENCE TO RELATED APPLICATION

This application claims priority based upon my copending Provisional Application Ser. No. 60/592,641; filed Aug. 2, 2004.

### BACKGROUND OF THE INVENTION

1. Field of the Invention

The present invention relates generally to remotely operated lights, and, more particularly, to remotely operated lights especially useful to hunters and other outdoors persons.

2. Description of the Prior Art

The use of remotely operated lights is well known in the art. More specifically, remotely operated lights are often used for locating objects that may be difficult to locate, such as vehicles in a parking lot.

Throughout the years, a number of innovations have been developed relating to remotely operated lights, and the following U.S. patents are representative of some of those innovations: U.S. Pat. Nos. 5,183,951, 5,278,556, 5,786,758, 6,239,701, and 6,580,368. More specifically, U.S. Pat. No. 5,183,951 discloses a weaponry signal apparatus, and each of U.S. Pat. Nos. 5,278,556, 5,786,758, 6,239,701, and 6,580,368 discloses a vehicle locating device. It is noted that none of the above-cited patents provides a strap assembly or the like for attaching a remotely operated light to a tree or the like. With a strap assembly, a remotely operated light can be suspended from an overhead support, such as the branch of a tree.

For a hunter or other outdoors person who wishes to establish a location to return to after wandering in a ft, it would be desirable if a remotely operated light could be attached to a tree or the like to mark the location to return to, so that the person can remotely operate the light attached to the location to provide a visible signal for the location.

More specifically, for convenience and ease of use, it would be desirable if a remotely operated light could be attached to a tree or the like with a strap assembly to mark the location to return to.

Still other features would be desirable in a remote-controlled locator light apparatus. For example, for a remotely operated locator light, there may be times when it is desired to cause the locator light to flash in order to readily attract attention.

In addition, to assure that a remotely operated lights does not remain “on” for an extended period of time, to preserve battery power, it would be desirable if a remotely operated lights had a programmable timer.

Since a person can wander from a location to return to in any direction from the location, it would be desirable if a remotely operated light could be visible from remote locations that are within a full 360 degrees around the location to return to.

Thus, while the foregoing body of prior art indicates it to be well known to use remotely operated lights, the prior art described above does not teach or suggest a remote-controlled locator light apparatus which has the following combination of desirable features: (1) provides a remotely operated light that can be attached to a tree or the like to mark the location to return to, so that the person can remotely operate the light attached to the location to provide a visible signal for the location; (2) provides a remotely operated light that can be attached to a tree or the like with a strap assembly to mark the location to return to; (3) can cause the locator light to flash in order to readily attract attention; (4) can have a programmable timer; (5) can be suspended from an overhead support, such as the branch of a tree; and (6) can be visible from remote locations that are within a full 360 degrees around the location to return to. The foregoing desired characteristics are provided by the unique remote-controlled locator light apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a remote-controlled locator light apparatus which includes a portable transmitter unit for transmitting an activation signal. A portable remote-controlled locator light unit receives the activation signal and is activated by the activation signal to emit a visible light signal. Suspension attachment means are provided for suspending the portable remote-controlled locator light unit from an object. The portable transmitter unit is battery powered.

The object to which the portable remote-controlled locator light unit is attached can be a standing object. The standing object can be a part of a tree, such as a tree branch, a hunting blind, a tree stand, or the like.

The transmitter unit can transmit an electromagnetic activation signal, and the remote-controlled locator light unit receives the electromagnetic activation signal and is activated by the electromagnetic activation signal.

The portable remote-controlled locator light unit includes a battery power source. A receiver assembly is electrically connected to the battery power source for receiving the electromagnetic activation signal. A signal driver assembly is electrically connected to the battery power source and the receiver assembly. A light source is electrically connected to the battery power source and the signal driver assembly, and a housing is provided for housing the battery power source, the receiver assembly, the signal driver assembly, and the light source.

The housing includes transparent light source covers adjacent to the light source for allowing light rays emitted from the light source to pass therethrough. The transparent light source covers substantially surround the light source in a horizontal plane. Preferably, the transparent light source covers provide a glowing light signal and prevent the casting of a clearly defined light beam. Also, preferably, the glowing light signal should stay on only a few minutes before going out. This would prevent excessive battery use.

Alternatively, a programmable timer may be located in the housing connected between the battery source and the light source. By setting the timer, the light source may be activated foe pre-determined periods of time such as after dusk and before sunrise. The timer will include means to automatically de-activate the light source after the predetermined timed interval expires.

The suspension attachment means can include a strap assembly which is connected to the portable remote-controlled locator light unit. The strap assembly can include a first strap member, a first buckle connected to the first strap member, a second strap member, and a second buckle connected to the second strap member. A key can be provided for unlocking the first buckle from the second buckle. The housing can include an identification tag area.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved remote-controlled locator light apparatus which has all of the advantages of the prior art and none of the disadvantages.

It is another object of the present invention to provide a new and improved remote-controlled locator light apparatus which may be easily and efficiently manufactured and marketed.

It is a further object of the present invention to provide a new and improved remote-controlled locator light apparatus which is of durable and reliable construction.

An even further object of the present invention is to provide a new and improved remote-controlled locator light apparatus which is susceptible of a low cost of manufacture with regard to both materials and labor, and which accordingly is then susceptible of low prices of sale to the consuming public, thereby making such remote-controlled locator light apparatus available to the buying public.

Still yet a further object of the present invention is to provide a new and improved remote-controlled locator light apparatus which provides a remotely operated light that can be attached to a tree or the like to mark the location to return to, so that the person can remotely operate the light attached to the location to provide a visible signal for the location.

Still another object of the present invention is to provide a new and improved remote-controlled locator light apparatus that provides a remotely operated light that can be attached to a tree or the like with a strap assembly to mark the location to return to.

Yet another object of the present invention is to provide a new and improved remote-controlled locator light apparatus which can cause the locator light to flash in order to readily attract attention.

Even another object of the present invention is to provide a new and improved remote-controlled locator light apparatus that can have a programmable timer.

Still a further object of the present invention is to provide a new and improved remote-controlled locator light apparatus which can be suspended from an overhead support, such as the branch of a tree.

Yet another object of the present invention is to provide a new and improved remote-controlled locator light apparatus that can be visible from remote locations that are within a full 360 degrees around the location to return to.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a preferred embodiment of the remote-controlled locator light apparatus of the invention, wherein a hunter is using a portable transmitter unit to turn on a portable remote-controlled locator light unit hung on a tree branch at or near a hunter's blind or the spot from where the hunter hunts.

FIG. 2 is a front view of the portable transmitter unit of the embodiment of the remote-controlled locator light apparatus shown in FIG. 1.

FIG. 3 is a front view of the portable remote-controlled locator light unit of the embodiment of the remote-controlled locator light apparatus of FIG. 1.

FIG. 4 is a side view of the portable remote-controlled locator light unit shown in FIG. 3 taken along line 4-4 thereof.

FIG. 5 is cross-sectional view of the portable remote-controlled locator light unit shown in FIG. 4 taken along line 5-5 thereof.

FIG. 6 is an enlarged view of the portion taken along line 6-6 in FIG. 4 wherein a strap can have a buckle connection between strap ends and can have a key for locking the strap ends together.

### DESCRIPTION OF THE PREFERRED EMBODIMENT

With reference to the drawings, a new and improved remote-controlled locator light apparatus embodying the principles and concepts of the present invention will be described.

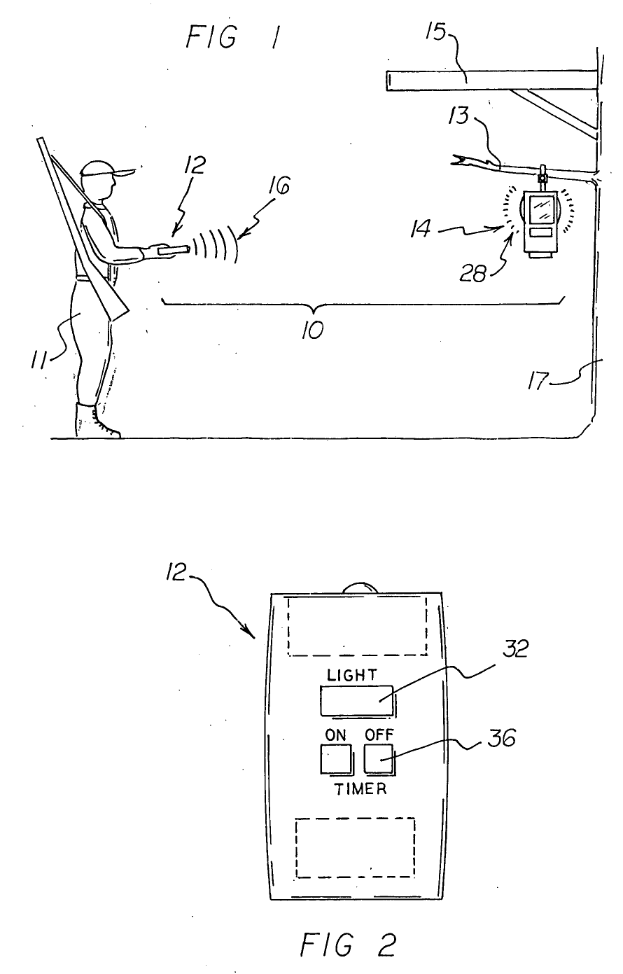

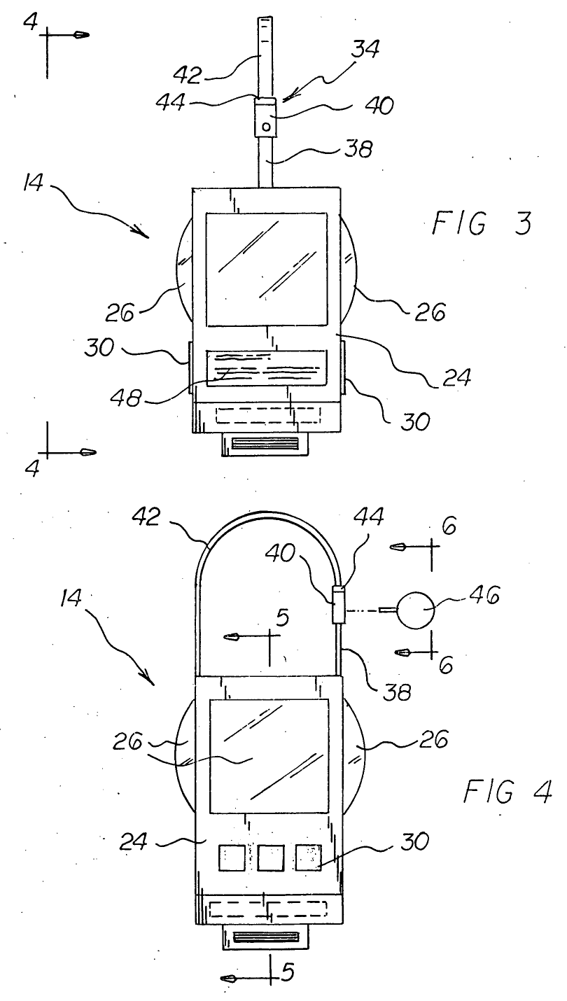

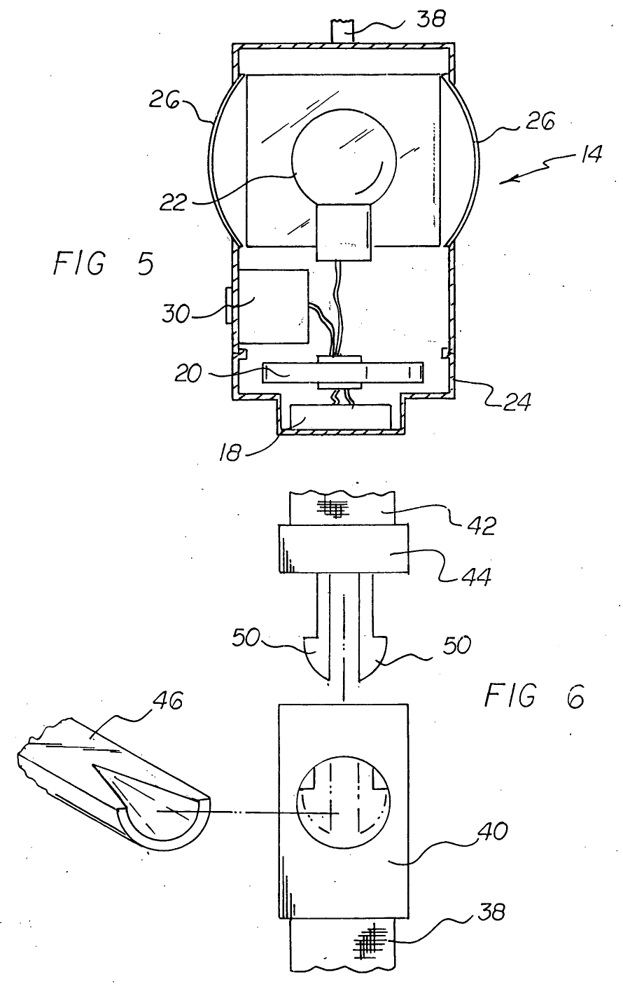

Turning to FIGS. 1-6, there is shown a preferred embodiment of the remote-controlled locator light apparatus of the invention generally designated by reference numeral 10. In the preferred embodiment, a remote-controlled locator light apparatus 10 includes a portable transmitter unit 12 for transmitting an activation signal. A portable remote-controlled locator light unit 14 receives the activation signal and is activated by the activation signal to emit a visible light signal. Suspension attachment means are provided for attaching the portable remote-controlled locator light unit 14 to an object.

Preferably, the portable transmitter unit 12 includes a “light” button 32 for activating the portable remote-controlled locator light unit 14 to emit a visible light signal. The portable transmitter unit 12 is battery powered.

The object to which the portable remote-controlled locator light unit 14 is attached can be a standing object. The standing object can be a part of a tree 17, such as a tree branch 13, or a hunting blind. Also, tree stand manufactures can incorporate the locator light unit as an integral part of the tree stand 15. Alternatively, the portable remote-controlled locator light unit 14 can be attached to the trunk of the tree 17.

The transmitter unit 12 can transmit an electromagnetic activation signal 16, and the remote-controlled locator light unit 14 receives the electromagnetic activation signal 16 and is activated by the electromagnetic activation signal 16.

The portable remote-controlled locator light unit 14 includes a battery power source. A receiver assembly 18 is electrically connected to the battery power source for receiving the electromagnetic activation signal 16. A signal driver assembly 20 is electrically connected to the battery power source and the receiver assembly 18. A light source 22 is electrically connected to the battery power source and the signal driver assembly 20, and a housing 24 is provided for housing the battery power source, the receiver assembly 18, the signal driver assembly 20, and the light source 22. Preferably, the housing 24 is weatherproof.

The housing 24 includes transparent light source covers 26 adjacent to the light source 22 for allowing light rays 28 emitted from the light source 22 to pass therethrough. The transparent light source covers 26 substantially surround the light source 22 in a horizontal plane. Preferably, the transparent light source covers 26 provide a glowing light signal and prevent the casting of a clearly defined light beam. Also, preferably, the glowing light signal should stay on only a few minutes before going out. This would prevent excessive battery use.

If desired, the portable transmitter unit 12 can include a programmable timer switch assembly which is adapted to provide an auxiliary activation signal capable of turning the light source on for predetermined timed intervals. In this respect, the portable transmitter unit 12 includes a “timer” button 36 for sending the auxiliary activation signal to the portable remote-controlled locator light unit 14. The receiver assembly 18 includes in a suitable circuit relationship therewith a programmable timer 30 which responds to the auxiliary activation signal from the portable transmitter unit 12 for connecting the light source to the battery source for the preset time interval desired. Controls for pre-setting the programmable timer may be included on the transmitter 12 or on the locator unit 14.

If desired, the programmable timer 30 can be operated independently of the transmitter unit 12. That is, the programmable timer 30 could be set manually to turn the light source 22 on automatically, such as low light times of the day, such as dawn and dusk. Also, in this way, the light source 22 would turn on automatically even if the portable remote-controlled locator light unit 14 were beyond the effective control distance of the portable transmitter unit 12.

The suspension attachment means can include a strap assembly 34 which is connected to the portable remote-controlled locator light unit 14. The strap assembly 34 can include a first strap member 38, a first buckle 40 connected to the first strap member 38, a second strap member 42, and a second buckle 44 connected to the second strap member 42. A key 46 can be provided for unlocking the first buckle 40 from the second buckle 44. The housing 24 can include an identification tag area 48.

To use the embodiment of the invention shown in FIGS. 1-6, a person, such as the hunter 11 shown in FIG. 1, goes to a remote location, such as a hunting blind, and the hunter 11 hangs the portable remote-controlled locator light unit 14 on or proximal to the hunting blind using the strap assembly 34. Then, the hunter 11 leaves the area of the portable remote-controlled locator light unit 14 and the hunting blind to return to another location, such as a campground or other remote area.

When the hunter 11 wishes to return to the area of the hunting blind, especially during a dark time of the day, such as before dawn, the hunter 11 presses the “light” button 32 on the portable transmitter unit 12 to send an electromagnetic activation signal 16 to the portable remote-controlled locator light unit 14 so that the portable remote-controlled locator light unit 14 will turn on the light source 22 to emit a light signal so that the hunter 11 can see where the portable remote-controlled locator light unit 14 and the hunting blind are located. Optionally, the pre-set programmable timer may be used to activate the light unit 14.

Since the transparent light source covers 26 substantially surround the light source 22, the hunter 11 will be able to see the signal light from the portable remote-controlled locator light unit 14 from substantially any direction that the hunter 11 approaches the portable remote-controlled locator light unit 14.

If desired, a remote-controlled locator light apparatus 10 made in accordance with the principles of the invention can be manufactured as part of a tree stand 15.

With respect to the strap assembly 34, the second buckle 44 can have barb members 50 which are received in barb-receiving portions (not shown) in the first buckle 40 and automatically lock with the barb-receiving portions when the second buckle 44 is connected to the first buckle 40. Subsequently, when the portable remote-controlled locator light unit 14 is no longer needed on the tree branch 13 near the hunting blind 15, the key 46 can be used to unlock the first buckle 40 from the second buckle 44. More specifically, the key 46 can be used to disengage the barb members 50 from the barb-receiving portions.

The components of the remote-controlled locator light apparatus of the invention can be made from inexpensive and durable metal and plastic materials. Also, conventional electrical and electronic components can also be employed.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved remote-controlled locator light apparatus that is low in cost, relatively simple in design and operation, and which may advantageously be attached to a tree or the like to mark a location to return to, so that the person can remotely operate the light attached to the location to provide a visible signal for the location to return to. With the invention, a remote-controlled locator light apparatus provides a remotely operated light that can be attached to a tree or the like with a strap assembly to mark the location to return to. With the invention, a remote-controlled locator light apparatus is provided which can cause the locator light to flash in order to readily attract attention. With the invention, a remote-controlled locator light apparatus is provided which can have a programmable timer. With the invention, a remote-controlled locator light apparatus is provided which can be suspended from an overhead support, such as the branch of a tree. With the invention, a remote-controlled locator light apparatus is provided which can be visible from remote locations that are within a full degrees around the location to return to.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A remote-controlled locator light apparatus, comprising:
a portable transmitter unit for transmitting an activation signal,
a portable remote-controlled locator light unit which receives said activation signal and is activated by said activation signal to emit a visible light signal, and
suspension attachment means for attaching said portable remote-controlled locator light unit to an object.

2. The apparatus of claim 1 wherein said portable transmitter unit is battery powered.

3. The apparatus of claim 1 wherein the object to which said portable remote-controlled locator light unit is attached is a standing object.

4. The apparatus of claim 1 wherein the standing object is a part of a tree.

5. The apparatus of claim 1 wherein the standing object is a tree branch.

6. The apparatus of claim 1 wherein:
said transmitter unit transmits an electromagnetic activation signal, and
said remote-controlled locator light unit receives said electromagnetic activation signal and is activated by said electromagnetic activation signal.

7. The apparatus of claim 1 wherein said portable remote-controlled locator light unit includes:
a battery power source,
a receiver assembly, electrically connected to said battery power source, for receiving said electromagnetic activation signal,
a signal driver assembly electrically connected to said battery power source and said receiver assembly,
a light source electrically connected to said battery power source and said signal driver assembly, and
a housing for housing said battery power source, said receiver assembly, said signal driver assembly, and said light source.

8. The apparatus of claim 7 wherein said housing includes transparent light source covers adjacent to said light source for allowing light rays emitted from said light source to pass therethrough.

9. The apparatus of claim 7 wherein said housing includes transparent light source covers which substantially surround said light source in a horizontal plane.

10. The apparatus of claim 7 wherein said housing includes an identification tag area.

11. The apparatus of claim 7 wherein said portable transmitter unit further provides an auxiliary activation signal for controlling a programmable timer in said portable remote-controlled locator light unit for controlling said light source.

12. The apparatus of claim 7, wherein said portable remote-controlled locator light unit further includes:
a programmable timer electrically connected to said battery power source and said signal driver assembly, wherein said receiver assembly responds to said auxiliary activation signal from said portable transmitter unit for controlling said programmable timer for driving said signal driver assembly for controlling said light source.

13. The apparatus of claim 1 wherein said suspension attachment means include a strap assembly connected to said portable remote-controlled locator light unit.

14. The apparatus of claim 13 wherein said strap assembly includes:
a first strap member,
a first buckle connected to said first strap member,
a second strap member, and
a second buckle connected to said second strap member.

15. The apparatus of claim 14, further including:
a key for unlocking said first buckle from said second buckle.
